(19) United States
(12) Patent Application Publication
(10) Pub. No.: US 2010/0324707 A1
(43) Pub. Date: Dec. 23, 2010

(54) METHOD AND SYSTEM FOR MULTIMEDIA DATA RECOGNITION, AND METHOD FOR MULTIMEDIA CUSTOMIZATION WHICH USES THE METHOD FOR MULTIMEDIA DATA RECOGNITION

(75) Inventors: HSIANG-HUA CHAO, TAIPEI (TW); CHI-CHEN CHENG, TAIPEI (TW)

Correspondence Address: PAI PATENT & TRADEMARK LAW FIRM, 1001 FOURTH AVENUE, SUITE 3200, SEATTLE, WA, 98154, US

(73) Assignee: IPEER MULTIMEDIA INTERNATIONAL LTD., TAIPEI (TW)

(21) Appl. No.: 12/730,127

(22) Filed: Mar. 23, 2010

(30) Foreign Application Priority Data
Jun. 19, 2009 (TW) 098120572

(51) Int. Cl. G06F 17/00; G06F 17/30

(52) U.S. Cl. 700/94; 707/812; 707/E17.005; 707/E17.009

(57) ABSTRACT

System and method for multimedia data recognition and method for multimedia customization which uses the method for multimedia data recognition are disclosed. Wherein the system includes a data capturing unit, a data recognition unit, and a waveform feature database. In which, the data capturing unit is for capturing a set of multimedia data to be recognized. The data recognition unit has a sound waveform conversion unit, a waveform feature capturing unit, and a waveform feature comparison unit, which are respectively used for converting sound data into waveform data, capturing waveform feature from waveform data, and comparing the captured waveform feature with at least a known waveform feature. By analyzing the sound data of the multimedia data, the multimedia data can be recognized.

### BACKGROUND OF THE INVENTION

1. Field of the Invention

The present invention related to method and system for data recognition, especially to the method and system for multimedia data recognition and a method for multimedia customization which uses the method for multimedia data recognition.

2. Description of the Related Art

The technology of digital video and multimedia improves rapidly, and the multimedia data is used for information sharing and entertainment. In general, the common multimedia data, such as a music video, is usually made with some particular videos, songs, captions, or pictures by the musical company. Thus, the content of the multimedia data can hardly be customized to match the requirements of all kinds of customers.

That is, is a user wants to change the content of a set of multimedia data, such as the content of a music video, he or she needs to search the requisite materials and finds proper software to combine those materials together.

### SUMMARY OF THE INVENTION

Because of aforementioned problems, the present invention discloses method and system for multimedia data recognition. By using the method and system for multimedia data recognition, some source materials are loaded corresponding to the recognized multimedia data. And then a user can make a customized multimedia data with the loaded source materials, or do some further applications.

For achieving the mentioned purposes, the present invention invites a system for multimedia data recognition. The system comprises a data capturing unit, a data recognition unit, and a waveform feature database. In which, the data capturing unit is for capturing a set of multimedia data wishing to be recognized. The set of multimedia data can be a music video, a song, or other multimedia data which has a set of sound data. The data recognition unit includes a sound waveform conversion unit, a waveform feature capturing unit, and a waveform feature comparison unit, respectively for converting the set of sound data into a set of waveform data, capturing at least a waveform feature from the set of waveform data, and comparing the waveform features with at least a known waveform feature. Additionally, the waveform feature database is for storing the known waveform features which correspond to sets of known multimedia data.

The present invention further invites a method for multimedia data recognition. The method includes: converting a set of sound data of a set of multimedia data to be recognized into a set of waveform data. Next, capturing at least a waveform feature of the set of waveform data. The waveform features can be a peak value location of the set of waveform data, etc. And then, the waveform features are compared with at least a known waveform feature which corresponds to a set of known multimedia data. According to the comparison result (which indicates the similarity between the waveform feature and the known waveform features), the set of multimedia data can be recognized.

Furthermore, a method for multimedia customization which uses the method for multimedia data recognition is disclosed. The method for multimedia customization includes the steps of method for multimedia data recognition. And after the set of multimedia data is recognized, at least a source material which relates to the recognized multimedia data is searched and loaded, and the source materials are transmitted to users for further editing. The user can do some editing operations such as changing the pictures and videos of the multimedia data, sound regulation, caption editing, and data format conversion, and can transmit the edited multimedia data to an electric device.

To sum up, the present invention captures the feature of waveform from the sound data of the multimedia data, and compares the captured waveform features with the known waveform features to recognize the multimedia data correspondingly. And then, the source materials which relates to the recognized multimedia data are loaded for multimedia customization and further applications according to the user's requirements.

For further understanding of the invention, reference is made to the following detailed description illustrating the embodiments and examples of the invention. The description is only for illustrating the invention, not for limiting the scope of the claim.

### BRIEF DESCRIPTION OF THE DRAWINGS

The drawings included herein provide further understanding of the invention. A brief introduction of the drawings is as follows:

FIG. 1 is a block diagram of an embodiment of multimedia recognition system according to the present invention;

FIG. 2 is a flow chart of an embodiment of method for multimedia data recognition according to the present invention;

FIG. 3 is a block diagram of an embodiment of multimedia customization system according to the present invention;

FIG. 4 is a block diagram of another embodiment of multimedia customization system according to the present invention;

FIG. 5 is a block diagram of still another embodiment of multimedia customization system according to the present invention;

FIG. 6 is a flow chart of an embodiment of method for multimedia customization according to the present invention; and

FIG. 7 is a flow chart of another embodiment of method for multimedia customization according to the present invention.

### DETAILED DESCRIPTION OF THE PREFERRED EMBODIMENTS

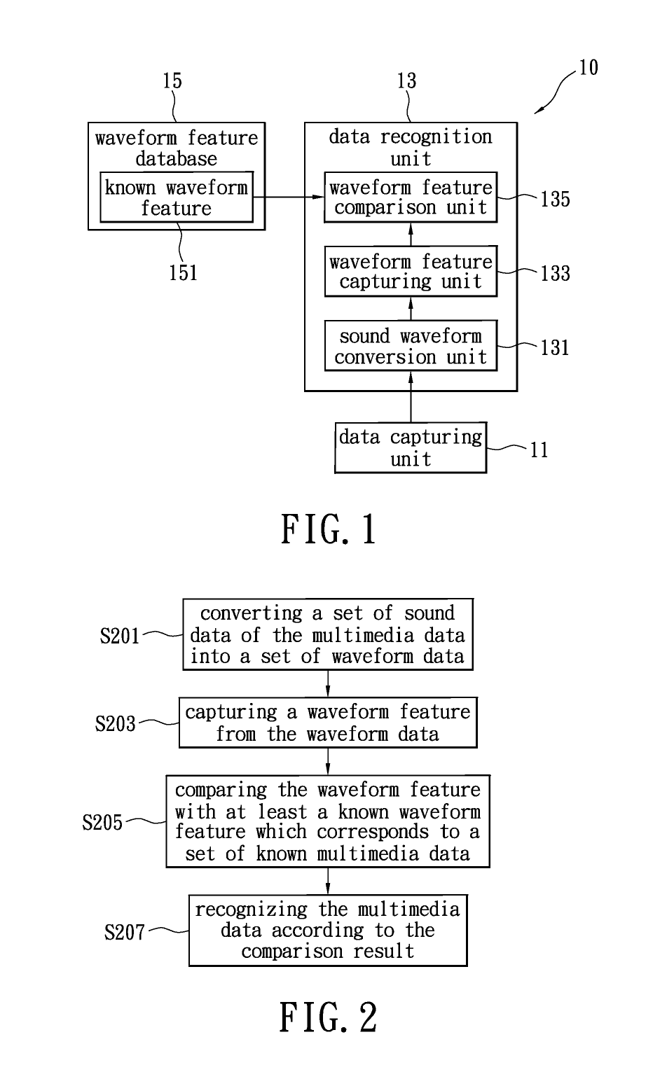

Please refer to FIG. 1, which is a block diagram of an embodiment of a multimedia recognition system 10. The multimedia recognition system 10 includes a data capturing unit 11, a data recognition unit 13, and a waveform feature database 15. In which, the data capturing unit 11 is for capturing a set of multimedia data to be recognized. For example, when a user uses a multimedia player (which can be hardware or software) to view a set of multimedia data, the data capturing unit 11 captures the played multimedia data as the set of multimedia data to be recognized. Then the data capturing unit 11 transmits the set of multimedia data to the data recognition unit 13 for further recognition. Specifically, the set of multimedia data can be a music video, a song, or any multimedia data which has a set of sound data.

The data recognition unit 13 is coupled with the data capturing unit 11, in which the data recognition unit 13 is for recognizing the set of multimedia data by comparing and analyzing the set of sound data of the set of multimedia data. Wherein, the data recognition unit 13 has a sound waveform conversion unit 131, which is for converting the set of sound data into a set of waveform data. For example, the set of sound data can be the data in MP3 format, and the set of waveform data can be the data in WAV format. The data recognition unit 13 further has a waveform feature capturing unit 133, which is for receiving the set of waveform data and capturing at least a waveform feature from the set of waveform data. Specifically, the waveform feature can be a peak value location of the set of waveform data, etc. After that, the waveform features are transmitted to a waveform feature comparison unit 135 which is also contained in the data recognition unit 13.

Additionally, after receiving the waveform features, the waveform feature comparison unit 135 then accesses at least a known waveform feature 151 which corresponds to a set of known multimedia data from the waveform feature database 15. Next, the waveform feature comparison unit 135 compares the waveform features with the known waveform features 151, in order to determine which known waveform feature 151 has the highest similarity with the waveform feature. Therefore, the multimedia data can be recognized to be the same data as the known multimedia data, in which the known multimedia data corresponds to the known waveform feature 151 with the highest similarity toward the waveform feature. Ways to determine the similarity between the waveform features and the known waveform features 151 includes calculating a Hamming distance between the waveform features and the known waveform features 151.

The Hamming distance between two strings of equal length is the number of different position-corresponding symbols. In other words, the Hamming distance measures the minimum number of substitutions required to change one string into the other, or the number of errors that transformed one string into the other. Thus, if the Hamming distance between two strings is 0, that means the two strings are exactly the same. And if the Hamming distance between two strings is 2, that means there are two different position-corresponding symbols between the two strings. Specifically, the smaller Hamming distance between two strings is, the higher similarity between two strings is.

Please refer to FIG. 2 correspondingly with FIG. 1, in which FIG. 2 is a flow chart of an embodiment of method for multimedia data recognition. The method includes: the sound waveform conversion unit 131 converts a set of sound data of a set of multimedia into a set of waveform data (S201). In which, the set of multimedia data can be a music video, a song, or a set of multimedia data which has a set of fixed sound data, etc. And then, the set of waveform data is transmitted to the waveform feature capturing unit 133. After that, the waveform feature capturing unit 133 captures a waveform feature of the received waveform data (S203), and then transmits the waveform feature to the waveform feature comparison unit 135. In which the waveform features can be a locations of peak value of the set of waveform data.

Next, the waveform feature comparison unit 135 loads at least a known waveform feature 151 which corresponds to a set of known multimedia data from the waveform feature database 15. After that, the waveform features are compared with the known waveform features 151 by the waveform feature comparison unit 135 (S205). In which the way to determine the similarity between the waveform feature and the know waveform feature 151 can include calculating the Hamming distance between them. And then, the data recognition unit 13 can recognize the set of multimedia data according to the comparison result generated by the waveform feature comparison unit 135 (S207). Specifically, the set of multimedia data is recognized to be the same data as the known multimedia data which corresponds to the known waveform feature 151 having the smallest Hamming distance toward the waveform feature.

For example, when the multimedia recognition system 10 receives a set of multimedia data to be recognized, the sound waveform conversion unit 131 then converts the format of a set of sound data of the multimedia data into WAV (waveform data). In which, the set of sound data doesn't need to be converted entirely. Otherwise, the sound waveform conversion unit 131 may determine a specific part of the sound data (such as thirty seconds data from the beginning of the set of sound data) to be converted into the set of waveform data.

After that, the waveform feature capturing unit 133 captures at least one waveform feature of the WAV data. For instance, the waveform feature capturing unit 133 divided the set of waveform data into four frequency bands according to bank scale. And then, the waveform feature capturing unit 133 finds the position of peak value in each frequency band, and records the four position data as a digital string (waveform feature). The captured digital string is then compared with the known waveform features 151 (which are also digital strings indicating the peak value position of some known multimedia data) one on one.

Specifically, for determining the similarity, the Hamming distance between the captured digital string and the known waveform feature 151 is calculated. According to that, the multimedia recognition system 10 can recognize the set of multimedia data to be the same data as the known multimedia data which corresponds to the known waveform feature 151 having the smallest Hamming distance toward the captured digital string.

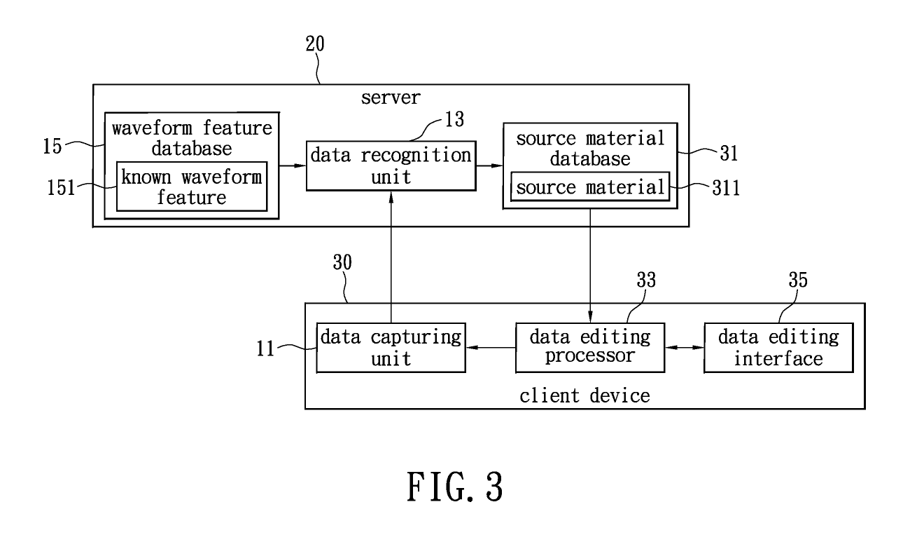

Please refer to FIG. 3, which is a block diagram of an embodiment of a multimedia customization system. The system includes a server 20 and a client device 30. Wherein the server 20 has a data recognition unit 13, a waveform feature database 15, and a source material database 31. The client device 30 can be a mobile phone, a computer, a PDA, etc., in which the client device 30 has a data capturing unit 11, a data editing processor 33, and a data editing interface 35.

The data capturing unit 11 is for capturing a set of multimedia data to be recognized, such as a music video or a song. In which the data capturing unit 11 is embedded with a multimedia player which can be either software or hardware. When a user uses the multimedia player to view a set of multimedia data, the played multimedia data can be transmitted to the data recognition unit 13 for further analysis, comparison, and recognition. The waveform feature database 15 stores at least a known waveform feature 151 which is for loading and comparing. Additionally, the source material database 31 stores all kinds of source materials 311 such as pictures, videos, captions, and titles. And after receiving the recognition result from the data recognition unit 13, the source material 31 then transmits the source materials 311 which relates to the recognized multimedia data to the data editing processor unit 33. Thus, the user can edit the set of multimedia data with the received source materials 311.

The user can transmit editing operations to the data editing processor 33 through the data editing interface 35 for editing the multimedia data. For instance, the multimedia data is a music video. The user can add words like “happy birthday!” on the screen of the music video, change the background video into photos, and regulate the sound pitch or eliminate vocals, etc.

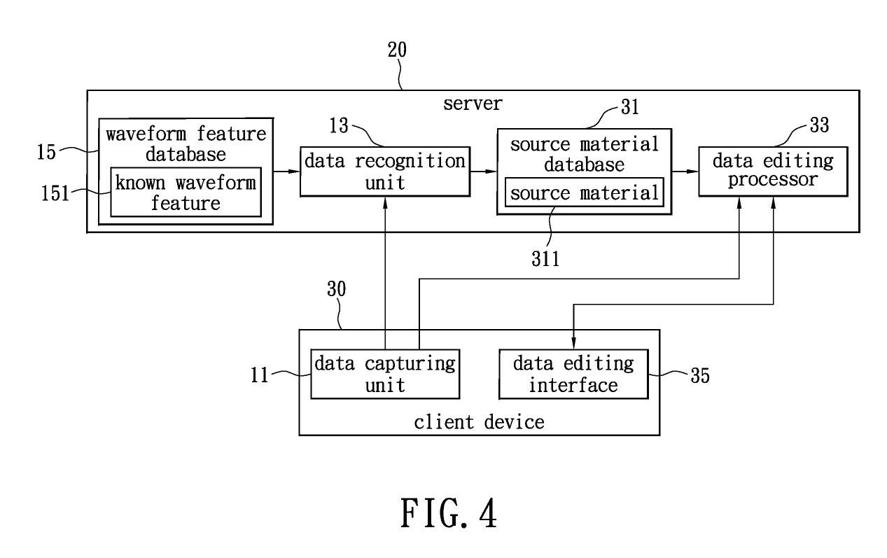

Please refer to FIG. 4, which is a block diagram of another embodiment of a multimedia customization system. The difference between FIG. 4 and FIG. 3 is that the data editing processor 33 of FIG. 4 is disposed in server 20, in order to reduce the data processing burden of the client device 30. Users edit the multimedia data through the data editing interface 35, but the processing is actually made by server 20.

Specifically, the data processing (such as data recognition done by the data recognition unit 13 and the data editing done by the data editing processor 33) can involve techniques of cloud computing to quicken the processing speed. Cloud computing is a style of computing in which dynamically scalable and often virtualized resources are provided as a service over the Internet for completing a task. The task can be divided into several sub-tasks, and each sub-task is separately processed. And each result is then combined as a final result of the original task. By using cloud computing, the data processing time can be reduced.

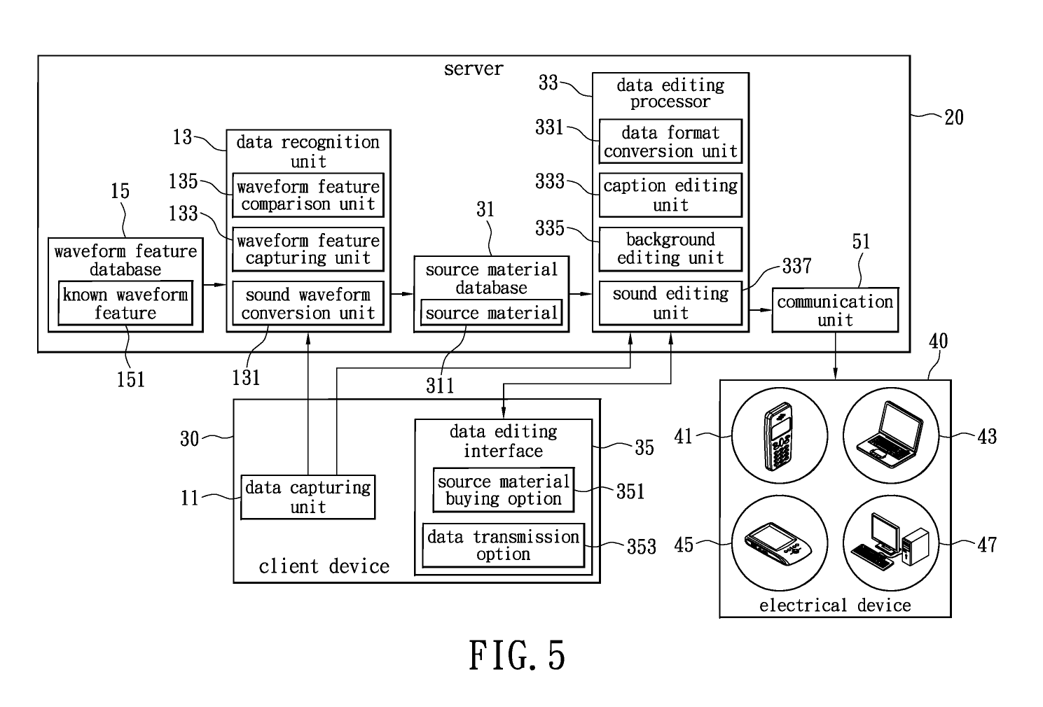

Please refer to FIG. 5, which is a block diagram of still another embodiment of a multimedia customization system. The system includes a server 20, a client device 30, and an electric device 40. Wherein the server 20 has a waveform feature database 15, a data recognition unit 13, a source material database 31, a data editing processor 33, and a communication unit 51. The client device 30 has a data capturing unit 11 and data editing interface 35.

The data capturing unit 11 and the data editing interface 35 can be software that integrated in a multimedia player. When the user uses the multimedia player to play a set of multimedia data such as a music video, the data capturing unit 11 transmits the multimedia data to the data recognition unit 13 of the server 20 for analysis. The data recognition unit 13 includes a sound waveform conversion unit 131, a waveform feature capturing unit 133, and a waveform feature comparison unit 135. After the multimedia data is recognized, the server 20 then loads the source materials 311 which relates to the recognized multimedia data and transmits the source materials 311 to client device 30.

Through the data editing interface 35, the user can do some operations and send the editing operations to the data editing processor 33. The data editing processor 33 has a data format conversion unit 331, a caption editing unit 333, a background editing unit 335, and a sound editing unit 337, for processing and editing the multimedia data according to the editing operations.

The server 20 further includes the communication unit 51, for transmitting the edited multimedia data to an electric device 40, such as a mobile phone 41, a notebook computer 43, a PDA 45, or a desktop computer 47. In which, the user can selects a data transmission option 353 of the data editing interface 35 for determining which electric device 40 the multimedia data sent to.

For example, if the user wants to say happy birthday to a far-away friend, the user can play a song which sings “happy birthday” by the multimedia player. Then the song is captured by the data capturing unit 11 and is transmitted to server 20 for recognition. After that, the server 20 sends some source materials 311 which relate to the song (such as some pictures of cakes, candles, etc.) back to the user. If the user buys those source materials 311, the source materials 311 can be used to edit the song by the user, such as adding the picture of cakes on the background screen of the song, or adding words like “Happy birthday! My friend”, etc. After the editing, the user can choose to send the edited song to the friend’ mobile phone 41 by the communication unit 51.

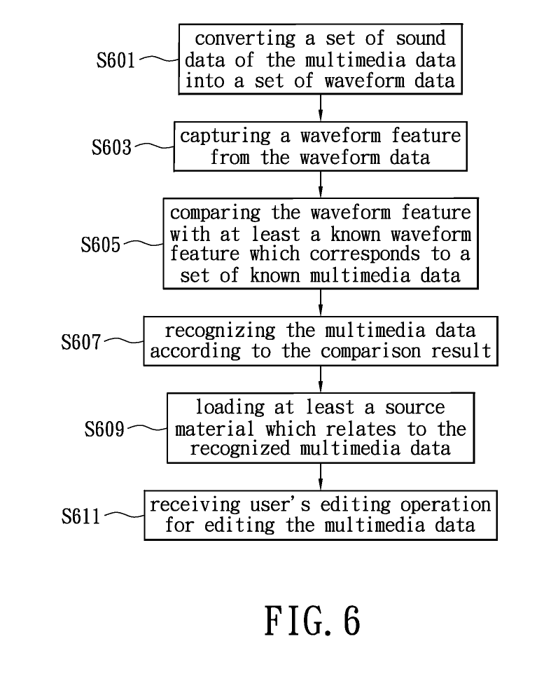

Please refer to FIG. 6 correspondingly with FIG. 5, in which FIG. 6 is a flow chart of an embodiment of method for multimedia customization which uses the mentioned method for multimedia data recognition. The method for multimedia customization includes: sound waveform conversion unit 131 converts a set of sound data of a set of multimedia data into a set of waveform data (S601), such as converting the sound data which is MP3 format into the waveform data which is WAV format. And then, the waveform data is transmitted to the waveform feature capturing unit 133. After that, the waveform feature capturing unit 133 captures at least a waveform feature from the waveform data (S603), such as the position of peak value of the waveform data, and transmits the waveform feature to the waveform feature comparison unit 135.

The waveform feature comparison unit 135 compares the received waveform feature with at least a known waveform feature 151 which corresponds to a set of known multimedia data (S605). In which the comparing manner can include calculating the Hamming distance between the waveform feature and the known waveform feature 151 one on one. After that, the data recognition unit 13 can recognize the multimedia data according to the comparison result (S607).

Next, according to the recognized multimedia data, the server 20 loads at least a source material 311 which relates to the recognized multimedia data from the source material database 31 (S609). Lastly, the editing operations are received by the server 20 through data editing interface 35 for editing the multimedia data (S611). In which the editing operation includes changing captions or titles, adding words, replacing background pictures, regulating pitch of sound, and eliminating vocals, etc.

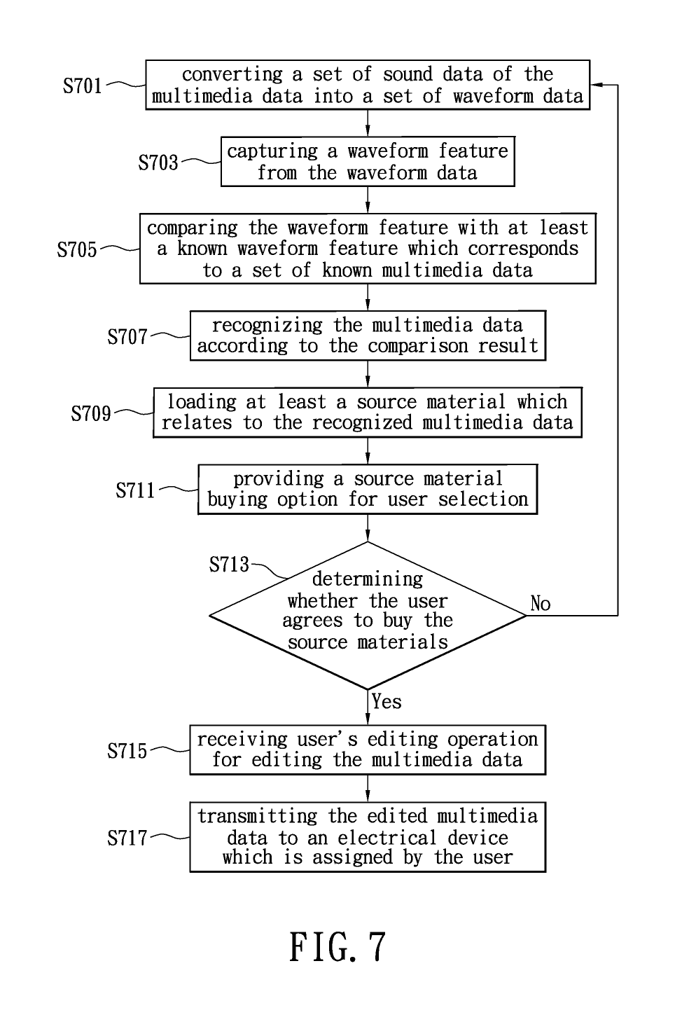

Please refer to FIG. 7 correspondingly with FIG. 5, in which FIG. 7 is a flow chart of another embodiment of method for multimedia customization which uses the mentioned method for multimedia data recognition. The method for multimedia data customization includes: sound waveform conversion unit 131 converts a set of sound data of a set of multimedia data into a set of waveform data (S701), and sends the waveform data to the waveform feature capturing unit 133. And then the waveform feature capturing unit 133 captures at least a waveform feature of the waveform data (S703), and transmits the waveform feature to the waveform feature comparison unit 135. After that, the waveform feature comparison unit 135 compares the received waveform feature with at least a known waveform feature 151 which corresponds to a set of known multimedia data (S705), so that the data recognition unit 13 can recognize the multimedia data according to the comparison result (S707).

Next, according to the recognized multimedia data, the server 20 loads at least a source material 311 which relates to the recognized multimedia data from the source material database 31 (S709), and provides a source material buying option 351 for user selection (S711). And then, the server 20 determines whether the user wants to buy the source materials 311 (S713). The server 20 then receives the editing operations only if the determination result is positive (S715). Lastly, the server 20 transmits the edited multimedia data to the electric device 40 which is chosen by the user (S717).

The differences between FIG. 7 and FIG. 6 are that the method in FIG. 7 provides the source material buying option 351. And the loaded source materials 311 are provided to the user for editing multimedia data only if the user agrees to buy them. Additionally, the method in FIG. 7 further provides data transmitting capability to user, for sending the edited multimedia data to the assigned electric device 40 by the communication unit 51.

As disclosed above, the present invention recognizes a multimedia data by capturing the waveform feature of a set of sound data of the multimedia data. And then the relative source materials are loaded and provided to user for editing the multimedia data. Therefore, the multimedia customization can be achieved, and the edited multimedia data can be used for further application.

Some modifications of these examples, as well as other possibilities will, on reading or having read this description, or having comprehended these examples, will occur to those skilled in the art. Such modifications and variations are comprehended within this invention as described here and claimed below. The description above illustrates only a relative few specific embodiments and examples of the invention. The invention, indeed, does include various modifications and variations made to the structures and operations described herein, which still fall within the scope of the invention as defined in the following claims.

What is claimed is:

1. A system for multimedia data recognition, comprising:
a data capturing unit for capturing a set of multimedia data to be recognized;
a data recognition unit coupled with the data capturing unit, including:
a sound waveform conversion unit for converting a set of sound data into a set of waveform data;
a waveform feature capturing unit coupled with the sound waveform conversion unit, in which the waveform feature capturing unit is for capturing at least a waveform feature of the set of waveform data;
a waveform feature comparison unit coupled with the waveform feature capturing unit, in which the waveform feature comparison unit is for comparing the waveform feature with at least a known waveform feature; and
a waveform feature database coupled with the data recognition unit, in which the waveform feature database stores the known waveform features which correspond to at least a set of known multimedia data.

2. The system as in claim 1, wherein the waveform feature includes a peak value location of the set of waveform data.

3. The system as in claim 1, wherein the waveform feature comparison unit compares the waveform feature with the known waveform feature, is that the waveform comparison unit calculates a Hamming distance between the waveform feature and the known waveform feature.

4. The system as in claim 1, wherein the data recognition unit recognizes the set of multimedia data according to the comparison result between the waveform feature and the known waveform feature.

5. The system as in claim 4, wherein the data recognition unit recognizes the set of multimedia data according to the comparison result, is that determining the set of multimedia data is identical to the set of known multimedia data corresponding to the known waveform feature which has the highest similarity with the waveform feature.

6. The system as in claim 1, wherein the set of multimedia data is a music video or a song.

7. A method for multimedia data recognition, comprising:
converting a set of sound data of a set of multimedia data into a set of waveform data;
capturing at least a waveform feature from the set of waveform data;
comparing the waveform feature with a known waveform feature corresponding to a set of known multimedia data; and
recognizing the set of multimedia data according to the comparison result.

8. The method as in claim 7, wherein the waveform feature includes a peak value location of the set of waveform data.

9. The method as in claim 7, wherein the step of comparing the waveform feature with the known waveform feature, is that calculating a Hamming distance between the waveform feature and the known waveform feature.

10. The method as in claim 7, wherein the step of recognizing the set of multimedia data, is that determining the set of multimedia data is identical to the set of known multimedia data corresponding to the known waveform feature which has the highest similarity with the waveform feature.

11. The method as in claim 7, wherein the set of multimedia data is a music video or a song.

12. A method for multimedia customization which uses the method for data recognition described in claim 7, further comprising:
loading at least a source material according to the set of multimedia data which is recognized, in which the source materials are related to the set of recognized multimedia data; and
receiving at least a user editing operation which edits the set of multimedia data.

13. The method for multimedia customization as in claim 12, wherein the source materials include one of or combination of a video, a picture, a caption, and a title.

14. The method for multimedia customization as in claim 12, wherein the user editing operations include one of or combination of a data format converting operation, a title editing operation, a background editing operation, and a sound editing operation.

15. The method for multimedia customization as in claim 14, wherein the sound edition operation includes pitch regulation and vocals elimination.

16. The method for multimedia customization as in claim 12, further comprising:
receiving a command from a user for transmitting the set of multimedia data to an electric device.

17. The method for multimedia customization as in claim 16, further comprising:
transmitting the set of multimedia data to the electric device.

18. The method for multimedia customization as in claim 12, further comprising:
providing a source material buying option which can be selected by a user.

19. The method for multimedia customization as in claim 18, further comprising:
determining whether to provide the source material to the user according to the selection received by the source material buying option.
